(19) United States
(12) Patent Application Publication
(10) Pub. No.: US 2018/0158010 A1
(43) Pub. Date: Jun. 7, 2018

(54) User Operation Selection and/or Modification Based on Determined User Skills/Skill Limitations

(71) Applicant: International Business Machines Corporation, Armonk, NY (US)

(72) Inventors: Jeremy A. Greenberger, Raleigh, NC (US); Jana H. Jenkins, Raleigh, NC (US)

(21) Appl. No.: 15/366,055

(22) Filed: Dec. 1, 2016

(51) Int. Cl. G06Q 10/06

(52) U.S. Cl. CPC G06Q 10/063112

(57) ABSTRACT

Mechanisms are provided for selecting user operations and/or modifying user operations based on the determined user skills and/or skill limitations of a user. The mechanisms obtain user data associated with a user and determine one or more user skills of the user based on analysis of the user data. The mechanisms analyze characteristics of tasks of a plurality of user operations stored in user operation data structures in a user operations knowledge database. The mechanisms identify a subset of user operations for which, for each task of each operation in the subset of operations, there is a match of the one of more user skills of the user with one or more required skills for performing the task. Moreover, the mechanisms select a recommended user operation from the subset of operations and output the recommended user operation to a computing device associated with the user.

### BACKGROUND

The present application relates generally to an improved data processing apparatus and method and more specifically to mechanisms for selecting user operations and/or modifying user operations based on the determined user skills and/or skill limitations of a user.

Various computer based systems exist for assisting people with the organization of their cooking recipes for quick retrieval and use. These computing systems are essentially database systems that store data and retrieve the data in response to user requests.

Recently, International Business Machines (IBM) Corporation of Armonk, N.Y., has released an intelligent cooking recipe application referred to as IBM Chef Watson™. IBM Chef Watson™ searches for patterns in existing recipes and combines them with an extensive database of scientific (e.g., molecular underpinnings of flavor compounds) and cooking related information (e.g., what ingredients go into different dishes) with regard to food pairings to generate ideas for unexpected combinations of ingredients. In processing the database, IBM Chef Watson™ learns how specific cuisines favor certain ingredients and what ingredients traditionally go together, such as tomatoes and basil. The application allows a user to identify ingredients that the user wishes to include in the recipe, ingredients that the user wishes to exclude, as well as specify the meal time (breakfast, lunch, dinner), course (appetizer, main, dessert), and the like.

The IBM Chef Watson™ has inspired the creation of a IBM Chef Watson™ food truck, a cookbook entitled Cognitive Cooking with Chef Watson, Sourcebooks, Apr. 14, 2015, and various recipes including a barbecue sauce referred to as Bengali Butternut BBQ Sauce.

### SUMMARY

In one illustrative embodiment, a method is provided, in a data processing system comprising a processor and a memory comprising instructions which are executed by the processor to cause the processor to perform the method. The method comprises obtaining, by the data processing system, user data associated with a user and determining, by the data processing system, one or more user skills of the user based on analysis of the user data. The method further comprises analyzing, by the data processing system, characteristics of tasks of a plurality of user operations stored in user operation data structures in a user operations knowledge database. The method also comprises identifying, by the data processing system, a subset of user operations for which, for each task of each operation in the subset of operations, there is a match of the one of more user skills of the user with one or more required skills for performing the task. In addition, the method comprises selecting, by the data processing system, a recommended user operation from the subset of operations. Furthermore, the method comprises outputting, by the data processing system, the recommended user operation to a computing device associated with the user.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a cognitive system in a computer network;

FIG. 2 is a block diagram of an example data processing system in which aspects of the illustrative embodiments are implemented;

FIG. 3 illustrates a request processing pipeline for processing an input request in accordance with one illustrative embodiment;

FIG. 4 is an example diagram of a graphical user interface via which a user may provide feedback for use in machine learning operations in accordance with one illustrative embodiment; and

FIG. 5 is a flowchart outlining an example operation for providing a recommended recipe in accordance with one illustrative embodiment.

### DETAILED DESCRIPTION

The illustrative embodiments provide mechanisms for identifying the skills that a user possesses and/or skill limitations of a user with regard to the performance of actions to achieve a desired operation comprising a plurality of actions requiring certain skills to perform those actions, such as to perform actions with regard to recipe preparation. This information is used to suggest operations that the user can perform or modify an operation with regard to one or more actions based on the skills or skill limitations of the user. For example, in the cooking domain, the information about the user's skills and/or skill limitations may be used to suggest recipes for the user as well as possibly modify recipes based on the identified skills/skill limitations of the user.

It should be appreciated that the example embodiments described herein will make reference to a cooking domain and the operations being the preparation of recipes so as to generate an edible food item or dish. However, the present invention is not limited to such. Rather, the present invention may be used with any operation in which a series of human performed actions are performed so as to achieve the operation, where one or more of these actions require particular skills to perform. These skills may be physical skills of the user used to physically manipulate elements of an environment, mental skills of the user used to handle a task, or any combination of physical and mental skills. For example, the operation may be in the manufacturing domain in which an item is being manufactured and certain skills are required for actions to be performed to manufacture the item. The operation may be in a medical field in which certain skills are required to perform a medical procedure, laboratory test, administration of a treatment, etc. Any domain and operation may be the subject of the mechanisms of the illustrative embodiments. However, for ease of explanation, the following description will assume a cooking domain with the operations being preparation of a recipe using ingredient preparation and cooking actions that may require various physical and/or mental skills.

It is recognized that not all users have similar skill sets and may in fact have skill limitations, i.e. restrictions on a user's ability to perform particular tasks, due to various physical and/or mental factors that may not be in their direct control. For example, a user may have a medical condition that affects their ability to perform certain operations or instructions of a recipe. For example, a user may have weak motor skills and/or may not be able to chop ingredients or twist a bottle due to an arthritis condition. Thus, recipes that require ingredients that requiring chopping or opening of bottles that have twist tops may be beyond the skills available to the user due to their medical condition.

Moreover, the skills and/or skill limitations of the user may change dynamically, such as when the user is experiencing a particular temporary increase in difficulty to perform actions requiring certain skills due to a temporary change in the user's medical condition, e.g., an arthritis flare-up, broken bone, strain, or the like. Thus, dynamic determination of the user's skills and/or skill limitations may be required to provide an adequate recommendation regarding operations that the user may perform.

The illustrative embodiments provide mechanisms for evaluating operations that may be performed by a user based on the user's skills and/or skill limitations. Based on the evaluation, particular operations may be selected for the user and/or actions in a series of actions required to perform an operation may be updated in view of the user's skills and/or skill limitations so as to make the operation achievable by the user. A recommendation for the operation may then be generated and output to the user.

As a domain specific example, within the cooking domain, a user may request that a recipe be provided with certain criteria, e.g., including particular ingredients and/or particular categories of dishes or food items, such as a dinner dish having chicken and potatoes, for example. The mechanisms of the illustrative embodiments may receive such a request and identify the user from which the request is received. A user profile for the user is retrieved in which there is information specifying the skills and/or skill limitations of the user with regard to actions that the user is able to perform. The user profile may be used to identify a set of domain specific actions that the user is able to perform, e.g., cooking actions and/or ingredient preparation actions. This set of domain specific actions may then be used as filter criteria for selecting operations, e.g., recipes, which the user is able to achieve or perform successfully, based on the series of actions that need to be performed. This filter criteria may be used along with other criteria specified in the request to select one or more operations to return as recommended operations for the user or otherwise weight operation recommendations along with other weights as generated by a cognitive system to identify a ranked listing of candidate operation recommendations. For example, a recipe that includes chicken and rosemary may be selected in which all of the cooking actions or ingredient preparation actions are able to be performed by the user. For example, if the user is having an arthritis flare-up, the recipe may have actions that do not require fine motor skills to achieve, whereas other recipes that do require fine motor skills may be filtered out.

In some illustrative embodiments, in addition to, or in replacement of, the filtering out of complete operations based on the skills and/or skill limitations of the user in the user profile, or applying/modifying weights associated with operations requiring skills that violate skill limitations of a user, the illustrative embodiments may also determine modifications to one or more operations that would accommodate the skills and/or skill limitations of the user. These modifications may replace or otherwise modify individual actions in a series of actions required to achieve the operation successfully so that the replacement or modified action is one that can be performed by the user taking into account the user's skills and/or skill limitations. For example, if a recipe calls for chopped vegetables, but the user has difficulty chopping vegetables, the recipe may be modified to replace this action with an action to add pre-cut vegetables. As another example, the recipe may call for the user to knead bread, however if the user has a sprained wrist this may be painful, and thus, this action may be replaced with an action to use a bread machine to knead the bread.

The correlation of skills and/or skill limitations with characteristics of a user may be learned through cognitive and/or machine learning processes. For example, skills and/or skill limitations may be associated with particular types of domain specific actions. For example, cognitive natural language processing of domain specific documentation in one or more corpora may be performed to associate concepts of particular actions that can and/or cannot be performed by individuals having particular skills and/or skill limitations. For example, medical documentation may be provided that indicates that a person with rheumatoid arthritis will have difficulty with fine motor skills. This information may be correlated with other information in an ontology or other domain specific knowledge base that indicates that certain cooking actions require fine motor skills, e.g., chopping vegetables. The ontology or domain specific knowledge base may be learned in a cognitive manner and/or may be subject matter expert (SME) supplied, for example.

With regard to machine learning, in addition to or alternative to the cognitive analysis and learning process, machine learning may be performed based on user feedback information. For example, in a first iteration, the mechanisms of the illustrative embodiments may provide recommendations to the user regarding particular recipes and/or replacement actions that accommodate the user's skills and/or skill limitations. After the recommendation, the user may provide feedback as to the appropriateness of the recommendation for the user. For example, the user may provide feedback as to how easy or difficult the recipe was to prepare based on their skills and/or skill limitations. The user may also provide subjective feedback as to how good or bad the user feels the replacement actions were to accommodate their skills and/or skill limitations. This information may be fed back into the mechanisms of the illustrative embodiments to modify the operations for selecting recipes and/or replacement actions. For example, various weighting values used for scoring or evaluating potential candidate recipes for the user may be modified based on the feedback.

As noted above, one of the aspects of the illustrative embodiments is the identification of skills and/or skill limitations of a user such that these can be used to identify operations that the user can achieve, e.g., recipes that the user can prepare, or modification of operations that would make them able to be achieved by the user. The identification of such skills and/or skill limitations may take many different forms depending on the desired implementation. For example, in some illustrative embodiments, sensors may be used within a physical environment and/or wearable by the user, that monitors the user's actions and, with analysis of the captured information, are able to determine the actions that the user is able to perform and/or not perform. For example, sensor data may be used to model activities in daily living (ADL) and identify ADL actions that the user performs or has difficulty performing. This information may be added to a user profile data structure as indicators of the actions that the user can or cannot perform.

In some illustrative embodiments, medical information about the user may be obtained from patient electronic medical records (EMRs) or the like, where this medical information includes patient information specifying medical conditions of the user, both more permanent medical conditions and temporary medical conditions. For example, the patient EMR information may indicate that the patient has recently been treated for a wrist sprain and thus, is unlikely to be able to perform operations requiring strenuous hand actions, e.g., kneading bread. Moreover, the patient EMR information may indicate that the patient has been diagnosed with rheumatoid arthritis and has limited fine motion skills. The former is a temporary condition while the latter is a more permanent condition. This information may be combined into a user profile to determine what domain specific actions the user is able to perform.

In still other illustrative embodiments, the skills and/or skill limitations may be manually input to the user profile. For example, a questionnaire may be presented to the user whereby the user may specify their skills and skill limitations. Based on the user's response to the questionnaire, corresponding identifiers of skills and/or skill limitations may be added to the user's profile data structure. Of course, any combination of the above described mechanisms of the illustrative embodiments, or other mechanisms that facilitate identifying skills and/or skill limitations of a user, may be used without departing from the spirit and scope of the present invention.

Thus, the illustrative embodiments provide mechanisms for assisting with the recommendation of operations, such as recipes, that a user can successfully achieve by taking into consideration the user's skills and/or skill limitations with regard to the actions that need to be performed to achieve successful completion of the operation. In the context of a cooking domain, a cognitive system based methodology, computer program product, and apparatus are provided which generates recommendations for recipes and/or modifications to recipes that the user's available skills will allow them to complete. In so doing, recipes that require skills that the user does not have or that match skill limitations of the user may be automatically removed from consideration or modified. Thus, recommendations generated by a cognitive system, such as IBM Chef Watson™, may be made more accurate and personalized to the particular user and their current skills and skill limitations.

Having given an overview of operations in accordance with one illustrative embodiment, before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

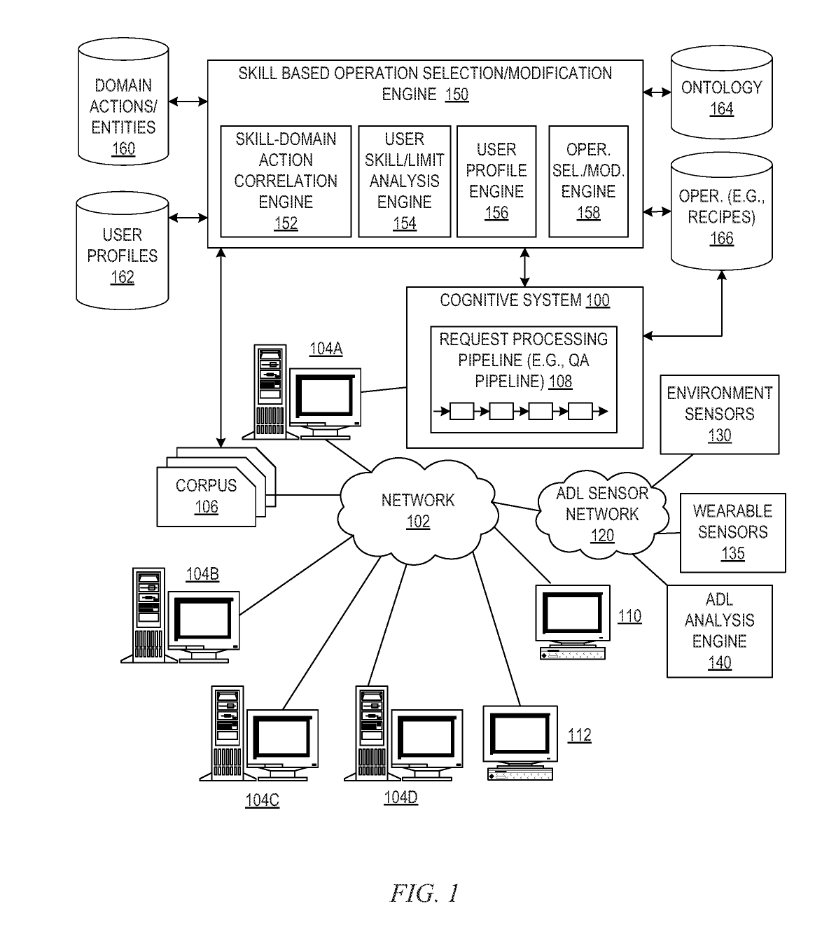

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example cognitive system for performing a cognitive operation based on knowledge gathered through a bootstrapped automated learning process in accordance with the illustrative embodiments. In the depicted example, the cognitive system implements a request processing pipeline, such as a Question Answering (QA) pipeline (also referred to as a Question/Answer pipeline or Question and Answer pipeline) for example, request processing methodology, and request processing computer program product with which the mechanisms of the illustrative embodiments are implemented. These requests may be provided as structure or unstructured request messages, natural language questions, or any other suitable format for requesting an operation to be performed by the cognitive system. As described in more detail hereafter, the particular application that is implemented in the cognitive system of the present invention is an application for evaluating skills and/or skill limitations of a user relative to an ordered set of actions to be performed on, with, or to, entities, to achieve an objective, where the actions and entities are domain specific. Again, for purposes of description, the domain will be assumed to be a cooking domain, the actions will be assumed to be cooking actions or ingredient preparation actions, and the entities may be cooking equipment, utensils, appliances, ingredients, or any other entity involved in the process of preparing a recipe to generate a consumable food or drink item.

It should be appreciated that the cognitive system, while shown as having a single request processing pipeline in the examples hereafter, may in fact have multiple request processing pipelines. Each request processing pipeline may be separately trained and/or configured to process requests associated with different domains or be configured to perform the same or different analysis on input requests (or questions in implementations using a QA pipeline), depending on the desired implementation. For example, in some cases, a first request processing pipeline may be trained to operate on input requests directed to providing cooking recipe recommendations for a user. In other cases, for example, the request processing pipelines may be configured to provide different types of cognitive functions or support different types of applications, such as one request processing pipeline being used for evaluating user patient electronic medical records (EMRs) to identify a user profile for the user, a pipeline for analyzing one or more corpora of domain specific documentation to generate a knowledge base of domain specific actions and correlation of such actions with skills and/or skill limitations, etc. In some cases, the different pipelines may be associated with different domains, such as one pipeline for a cooking domain, another for a manufacturing domain, another for a medical research domain, etc.

In some illustrative embodiments, the multiple pipelines may work in conjunction with each other. For example, the results generated by one pipeline may be used by another, e.g., the results of the knowledge base generation may be used to associate domain specific actions associated with skill limitations of a user as determined from patient EMRs for the user, which may be used to select recipe recommendations and/or modifications to recipes.

Moreover, each request processing pipeline may have their own associated corpus or corpora that they ingest and operate on, e.g., one corpus for cooking domain documents (e.g., comprising recipes and information specifying ingredients and/or actions associated with the cooking domain), another corpus for manufacturing domain related documents for manufacturing a specific object, a third corpus for medical laboratory test domain related documents, etc. In some cases, the request processing pipelines may each operate on the same domain of input questions but may have different configurations, e.g., different annotators or differently trained annotators, such that different analysis and potential answers are generated. The cognitive system may provide additional logic for routing input questions to the appropriate request processing pipeline, such as based on a determined domain of the input request, combining and evaluating final results generated by the processing performed by multiple request processing pipelines, and other control and interaction logic that facilitates the utilization of multiple request processing pipelines.

As noted above, one type of request processing pipeline with which the mechanisms of the illustrative embodiments may be utilized is a Question Answering (QA) pipeline. The description of example embodiments of the present invention hereafter will utilize a QA pipeline as an example of a request processing pipeline that may be augmented to include mechanisms in accordance with one or more illustrative embodiments. It should be appreciated that while the present invention will be described in the context of the cognitive system implementing one or more QA pipelines that operate on an input question, the illustrative embodiments are not limited to such. Rather, the mechanisms of the illustrative embodiments may operate on requests that are not posed as “questions” but are formatted as requests for the cognitive system to perform cognitive operations on a specified set of input data using the associated corpus or corpora and the specific configuration information used to configure the cognitive system. For example, rather than asking a natural language question of “What is a recipe for making a raspberry cheesecake?”, the cognitive system may instead receive a request of “generate a recipe for making a raspberry cheesecake,” or the like. It should be appreciated that the mechanisms of the QA system pipeline may operate on requests in a similar manner to that of input natural language questions with minor modifications. In fact, in some cases, a request may be converted to a natural language question for processing by the QA system pipelines if desired for the particular implementation.

As will be discussed in greater detail hereafter, the illustrative embodiments may be integrated in, augment, and extend the functionality of these QA pipeline, or request processing pipeline, mechanisms of a cognitive system with regard to performing automated recommendation generation for a user taking into account the user's skills and/or skill limitations. In particular the mechanisms of the illustrative embodiments may identify the domain specific actions that the user may perform or may not be able to perform, compare that information to required actions for successfully performing an operation, and selecting an operation that the user can successfully complete or modify the actions of an operation so that the user can successfully complete the operation. This may all be done based on a user profile data structure that identifies the skills and/or skill limitations of the user as well as one or more domain specific knowledge bases indicating a correspondence between domain specific actions and skills or skill limitations. Moreover, other knowledge bases may be used to associated user characteristics with skills or skill limitations, e.g., medical knowledge bases may correlate medical conditions with skill limitations, and this information in the knowledge bases may be used to generate the user profile. Furthermore, domain specific knowledge bases may be provided that indicate alternative actions or entities for modifying actions in an operation so as to accommodate a user's skills and/or skill limitations.

Thus in view of the cognitive system based embodiments described herein, it is important to first have an understanding of how cognitive systems and question and answer creation in a cognitive system implementing a QA pipeline is implemented before describing how the mechanisms of the illustrative embodiments are integrated in and augment such cognitive systems and request processing pipeline, or QA pipeline, mechanisms. It should be appreciated that the mechanisms described in FIGS. 1-3 are only examples and are not intended to state or imply any limitation with regard to the type of cognitive system mechanisms with which the illustrative embodiments are implemented. Many modifications to the example cognitive system shown in FIGS. 1-3 may be implemented in various embodiments of the present invention without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline or system (QA system) and/or process requests which may or may not be posed as natural language questions. The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., cooking domain, financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

As mentioned above, QA pipeline mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify these question and answer attributes of the content.

Operating on such content, the QA pipeline generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a cognitive system 100 implementing a request processing pipeline 108, which in some embodiments may be a question answering (QA) pipeline, in a computer network 102. For purposes of the present description, it will be assumed that the request processing pipeline 108 is implemented as a QA pipeline that operates on structured and/or unstructured requests in the form of input questions. One example of a question processing operation which may be used in conjunction with the principles described herein is described in U.S. Patent Application Publication No. 2011/0125734, which is herein incorporated by reference in its entirety. The cognitive system 100 is implemented on one or more computing devices 104A-D (comprising one or more processors and one or more memories, and potentially any other computing device elements generally known in the art including buses, storage devices, communication interfaces, and the like) connected to the computer network 102. For purposes of illustration only, FIG. 1 depicts the cognitive system 100 being implemented on computing device 104A only, but as noted above the cognitive system 100 may be distributed across multiple computing devices, such as a plurality of computing devices 104A-D.

The network 102 includes multiple computing devices 104A-D, which may operate as server computing devices, and 110-112 which may operate as client computing devices, in communication with each other and with other devices or components via one or more wired and/or wireless data communication links, where each communication link comprises one or more of wires, routers, switches, transmitters, receivers, or the like. In some illustrative embodiments, the cognitive system 100 and network 102 enables question processing and answer generation (QA) functionality for one or more cognitive system users via their respective computing devices 110-112. In other embodiments, the cognitive system 100 and network 102 may provide other types of cognitive operations including, but not limited to, request processing and cognitive response generation which may take many different forms depending upon the desired implementation, e.g., cognitive information retrieval, training/instruction of users, cognitive evaluation of data, or the like. Other embodiments of the cognitive system 100 may be used with components, systems, sub-systems, and/or devices other than those that are depicted herein.

The cognitive system 100 is configured to implement a request processing pipeline 108 that receive inputs from various sources. The requests may be posed in the form of a natural language question, natural language request for information, natural language request for the performance of a cognitive operation, or the like. For example, the cognitive system 100 receives input from the network 102, a corpus or corpora of electronic documents 106, cognitive system users, and/or other data and other possible sources of input. In one embodiment, some or all of the inputs to the cognitive system 100 are routed through the network 102. The various computing devices 104A-D on the network 102 include access points for content creators and cognitive system users. Some of the computing devices 104A-D include devices for a database storing the corpus or corpora of data 106 (which is shown as a separate entity in FIG. 1 for illustrative purposes only). Portions of the corpus or corpora of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus or corpora of data 106 for use as part of a corpus of data with the cognitive system 100. The document includes any file, text, article, or source of data for use in the cognitive system 100. Cognitive system users access the cognitive system 100 via a network connection or an Internet connection to the network 102, and input questions/requests to the cognitive system 100 that are answered/processed based on the content in the corpus or corpora of data 106. In one embodiment, the questions/requests are formed using natural language. The cognitive system 100 parses and interprets the question/request via a pipeline 108, and provides a response to the cognitive system user, e.g., cognitive system user 110, containing one or more answers to the question posed, response to the request, results of processing the request, or the like. In some embodiments, the cognitive system 100 provides a response to users in a ranked list of candidate answers/responses while in other illustrative embodiments, the cognitive system 100 provides a single final answer/response or a combination of a final answer/response and ranked listing of other candidate answers/responses.

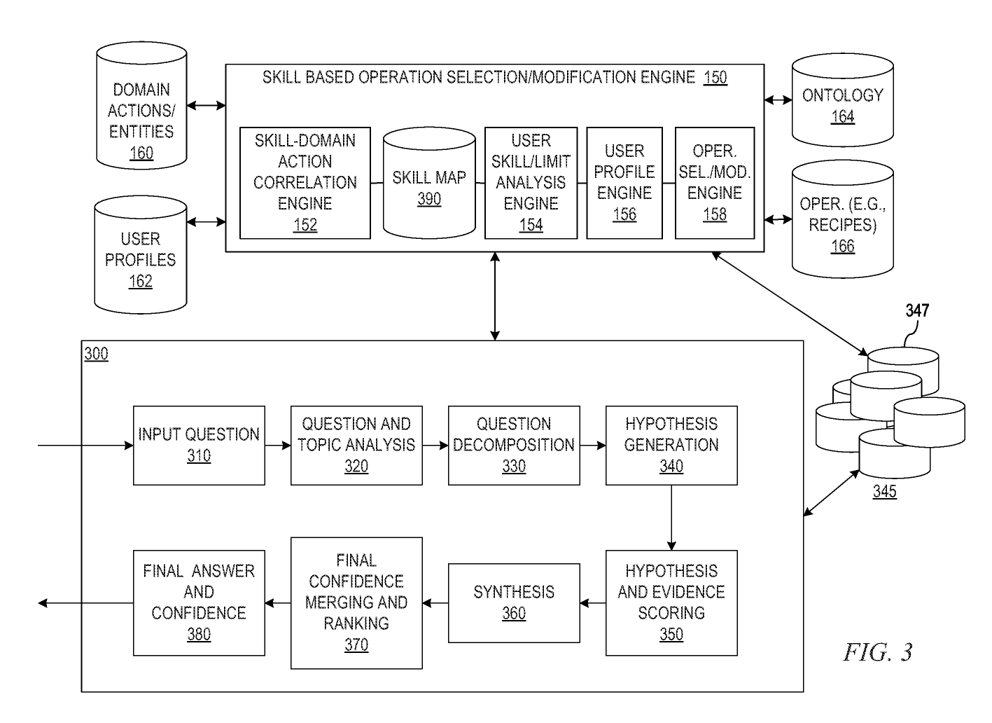

The cognitive system 100 implements the pipeline 108 which comprises a plurality of stages for processing an input question/request based on information obtained from the corpus or corpora of data 106. The pipeline 108 generates answers/responses for the input question or request based on the processing of the input question/request and the corpus or corpora of data 106. The pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a pipeline of the IBM Watson™ cognitive system receives an input question or request which it then parses to extract the major features of the question/request, which in turn are then used to formulate queries that are applied to the corpus or corpora of data 106. Based on the application of the queries to the corpus or corpora of data 106, a set of hypotheses, or candidate answers/responses to the input question/request, are generated by looking across the corpus or corpora of data 106 for portions of the corpus or corpora of data 106 (hereafter referred to simply as the corpus 106) that have some potential for containing a valuable response to the input question/response (hereafter assumed to be an input question). The pipeline 108 of the IBM Watson™ cognitive system then performs deep analysis on the language of the input question and the language used in each of the portions of the corpus 106 found during the application of the queries using a variety of reasoning algorithms.

The scores obtained from the various reasoning algorithms are then weighted against a statistical model that summarizes a level of confidence that the pipeline 108 of the IBM Watson™ cognitive system 100, in this example, has regarding the evidence that the potential candidate answer is inferred by the question. This process is be repeated for each of the candidate answers to generate ranked listing of candidate answers which may then be presented to the user that submitted the input question, e.g., a user of client computing device 110, or from which a final answer is selected and presented to the user. More information about the pipeline 108 of the IBM Watson™ cognitive system 100 may be obtained, for example, from the IBM Corporation website, IBM Redbooks, and the like. For example, information about the pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the cognitive system 100 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. In the case of a cooking domain implementation, for example, the request may be to recommend a recipe for generating a food or drink item, to actually generate a recipe, or the like, such that the analysis performed may be with regard to recipe instructions, ingredients, and cooking or food/drink preparation actions, for example.

In the context of the present invention, cognitive system 100 may provide a cognitive functionality for recommending an ordered set of actions for generating a desired result or achieving a particular objective, i.e. the successful completion of an operation. In the context of a cognitive system such as IBM Chef Watson™, for example, the cognitive functionality may be the selection of a recipe, generation of a recipe, modification of a recipe, or the like, based on skills or skill limitations associated with a user. The cognitive functionality may make use of user profile information obtained from the user, identified through cognitive analysis of user medical condition information, identified from cognitive analysis of sensor information from physical environment sensors and/or wearable sensors, or the like, which identifies or otherwise is correlated with skills and/or skill limitations that may be associated with the user. The skills and/or skill limitations may be correlated with domain specific actions that can/cannot be performed by a user which can then be used to identify recipes that the user is able to successfully complete. Moreover, in some cases, the domain specific actions may be used to identify modifications to recipes to allow the recipe to be successfully performed by the user.

As shown in FIG. 1, the cognitive system 100 is further augmented, in accordance with the mechanisms of the illustrative embodiments, to include logic implemented in specialized hardware, software executed on hardware, or any combination of specialized hardware and software executed on hardware, for implementing a skill based operation selection/modification engine 150 that operates to augment the selection/modification of operations, e.g., recipes, returned by the cognitive system 100 in response to a request, based on a user's identified skills and/or skill limitations. Moreover, the skill based operation selection/modification engine 150 may further comprise elements for learning skills/skill limitations of users and using this information to create or dynamically update user profiles specifying the user's skills/skill limitations. These user profiles may be used to correlate skills/skill limitations with domain specific actions, e.g., cooking actions, which can then be used to assist with the selection of an operation based on whether or not the operation requires particular skills that correlate with skills of the user and/or skill limitations. Moreover, in some cases, modifications to the operations may be identified so as to modify the operations to be achievable by the user based on their skills and/or skill limitations.

As shown in FIG. 1, the skill based operation selection/modification engine 150 comprises a skill-domain action correlation engine 152, a user skill/limit analysis engine 154, a user profile engine 156, and an operation selection/modification engine 158. The skill based operation selection/modification engine 150 may operate in conjunction with various knowledge bases including a knowledge database of domain actions/entities 160, user profiles 162, an ontology data structure 164, and a knowledge base of operations 166, which in the example embodiments are recipes for preparing a food or drink item.

The skill-domain action correlation engine 152 may operate in conjunction with the cognitive processing elements of the cognitive system 100 to analyze natural language content of a corpus or corpora 106 to identify relationships between skills and domain specific actions. For example, the corpus or corpora 106 may comprise natural language documentation that describes the preparation of food/drink items and as such, may comprise action terms specifying domain specific actions that are to be performed when preparing such food/drink items. For example, chopping vegetables associates the food preparation action “chop” with the entity “vegetable”. Correlations between domain specific actions and domain specific entities may be stored in the domain actions/entities knowledge base 160 and may also be represented in the domain specific ontology 164. The ontology 164 provides a hierarchical knowledge base by which to associate various types of entities with each other, various types of domain specific actions with these entities and with each other, and the like.

Moreover, these domain specific actions may be correlated with user skills that are required to perform such actions and/or skill limitations that are associated with such domain specific actions. Such correlation may be based on associations specified by subject matter experts (SMEs), as defined in natural language resources, such as dictionaries, synonym data structures, or the like. For example, the action of chopping involves a manual and vigorous hand based action and this may be specified in a dictionary data structure, a data structure manually input by a SME, or the like. As a result, this correlation may indicate that the action of chopping requires strong hand skills and such skills may be associated with the action. Alternatively, or in addition, a skill limitation may be that the action of chopping cannot be performed by persons that have weak hand skills.

The particular types of skills may be part of a predefined set of skills that may be associated with different domain specific actions. For example, skills may include fine motor hand skills, strong hand skills, weak hand skills, strong wrist rotation skills, weak wrist rotation skills, use of particular domain specific equipment, utensils, or appliances, and the like. A pre-defined listing of such skills may be configured in the resources of the skill based operation selection/modification engine 150 and may be used to associate skills, or skill limitations, with domain specific actions identified in natural language content and may also be used to associate skills, or skill limitations, with user profiles such that there is a common basis of skills/skill limitations by which to associate user capabilities with domain specific actions. It should be appreciated that the skills or skill limitations may not be domain specific and in fact may be reused with various different domains, may be domain specific, or may comprise a combination of domain specific and general skills/skill limitations.

In some cases, the skill-domain action correlation engine 152 may utilize machine learning techniques to learn associations of skills and/or skill limitations with domain specific actions. For example, users with particular skills that are determined to have performed certain domain specific actions may be a basis for learning that those skills are associated with those domain specific actions. For example, a user profile having specific skills indicated and those skills may be associated with actions performed by the user to achieve an operation. This information may be fed back into the skill-domain action correlation engine 152 which learns the association of the skills with the domain specific action over time, e.g., as more users perform similar actions and have similar skills or skill limitations, the associations are made stronger through machine learning. Ultimately, the skill-domain action correlation engine 152 generates one or more data structures correlating domain specific actions with skills in the pre-defined skill listing and/or skill limitations associated with the predefined skill listing.

The user skill/skill limit analysis engine 154 may make use of the cognitive system elements to perform natural language processing of the corpus or corpora 106, to associate skills and/or skill limits with characteristics of a user. For example, the corpus 106 may comprise medical knowledge documents that describe various medical conditions and associated symptoms, treatments, patient characteristics, etc. From this information and the features extracted from the natural language processing of such information, the user skill/skill limitation analysis engine 154 may associate different medical conditions with different symptoms which may be correlated with skills and/or skill limitations. For example, a medical document may indicate that one of the effects of rheumatoid arthritis is that the user will not be able to open medication or may have significant joint pain in the hands and feet. These characteristics may be associated with skills and/or skill limitations in the pre-defined skill listing data structure of the skill-based operation selection/modification engine 150, e.g., significant joint pain in the hands and feet may be associated with weak hand skills or no fine motor skills. Of course, associations of skills and/or skill limitations with user characteristics, such as medical conditions, may also be manually input by a subject matter expert (SME) or machine learned through analysis of users having particular characteristics and corresponding skills/skill limitations.

In other illustrative embodiments, the mechanisms of the illustrative embodiments may also communicate with devices that monitor the activities or actions performed by a user and thereby identify skills/skill limitations that the user may have. For example, the user skill/skill limit analysis engine 154 may obtain data from one or more devices associated with the user, e.g., a motion or activity tracking device, such as a FitBit™, Apple Watch™ from Apple Corporation, a mobile phone with global positioning capability and corresponding location determination software, or the like, which monitors the movements of the user to determine that the user is able to walk. This information may be provided to the user skill/skill limit analysis engine 154 so that the engine 154 now knows that the user is able to walk or not able to walk depending on the data detected by the third party device. Of course any analysis may be performed on any data that is able to be obtained from such motion or activity monitoring devices such that the indicators of skills/skill limitations may be either provided to the user skill/skill limit analysis engine 154 or otherwise determined by the user skill/skill limit analysis engine 154.

Moreover, skills/skill limitations may be deduced by the user skill/skill limit analysis engine 154 based on the skills/skill limitations already associated with the user, e.g., if the user has been determined to be able to run, then it may be deduced that the user is able to walk. Such associations of skills/skill limitations for deduction purposes may be specified in configuration data of the user skill/skill limit analysis engine 154, ontology data 164, or the like.

The user profile engine 156 provides logic that operates to generate/update a user profile for a user in the user profiles knowledge base 162. The user profile for the user specifies the skills and/or skill limitations associated with the user. These skills/limitations may be temporary or more permanent in nature and may be dynamically updated based on periodic evaluation of user information. The actual identification of such skills and/or skill limitations may take many different forms depending on the desired implementation.

For example, in some illustrative embodiments, the user profile engine 156 may obtain information from an activities of daily living (ADL) analysis engine 140 via an ADL sensor network 120 and network 102. Various environment sensors 130, such as cameras, audio capture devices, and the like, may be used to monitor an environment in which a user performs actions. These environment sensors 130 may provide sensor data to the ADL analysis engine 140 which analyzes the sensor data to determine actions that the user is able to perform and/or actions the user is not able to perform. These actions may be domain specific actions corresponding to those in the domain specific actions/entities knowledge base 160. Similarly, wearable sensors 135 may be provided as part of the ADL sensor network 120 which measure ranges of motion of the user with regard to various parts of the user's body with this information being provided to the ADL analysis engine 140 which determines corresponding actions that the user is able to perform. These actions associated with the user may be provided to the skill based operation selection/modification engine 150 via the network 102 which then correlates the actions with skills and/or skill limitations based on the correlations determined by engine 152. These identified skills/skill limitations may be added to the user's user profile via the user profile engine 156.

In some illustrative embodiments, medical information about the user may be obtained from patient electronic medical records (EMRs) or the like, such as may be part of a corpus or corpora 106. For example, the user's EMRs may be analyzed to identify patient information specifying medical conditions of the user, both more permanent medical conditions and temporary medical conditions. For example, the patient EMR information may indicate that the patient has recently been treated for a wrist sprain and thus, based on an association of this user characteristic with skills/skill limitations learned by engine 154, is unlikely to be able to perform operations requiring strong hand actions, e.g., kneading bread. Moreover, the patient EMR information may indicate that the patient has been diagnosed with rheumatoid arthritis. Based on the association of user skills/skill limitations with user characteristics, as learned by engine 154, the medical condition may be associated with particular skills and/or skill limitations, e.g., a user with rheumatoid arthritics has weak fine motion skills and thus, is unlikely to perform actions such as slicing carrots or the like. The former is a temporary condition while the latter is a more permanent condition. This information may be combined into a user profile to further associate skills and/or skill limitations with the user.

In still other illustrative embodiments, the skills and/or skill limitations may be manually input to the user profile. For example, a questionnaire may be presented by the user profile engine 156 to the user, such as via the user's client computing device 110, whereby the user may specify their skills and skill limitations. Based on the user's response to the questionnaire, corresponding identifiers of skills and/or skill limitations may be added to the user's profile data structure.

Of course, any combination of the above described mechanisms of the illustrative embodiments, or other mechanisms that facilitate identifying skills and/or skill limitations of a user, may be used without departing from the spirit and scope of the present invention. Thus, the skills/skill limitations associated with the user may be determined from one or more of user input, ADL automatic detection, medical information processing, or the like.

Thus, via the mechanisms described above, associations of skills and/or skill limitations with domain specific actions are generated, associations of user characteristics with skills and/or skill limitations are generated, and based on these associations, a user profile is generated for a user that specifies the particular skills and/or skill limitations that the user has, both more permanent and temporary. The user profile may then be used with subsequent requests being submitted by the user for an operation of the cognitive system 100. For example, the user profile may be used by the cognitive system 100 in conjunction with the operation selection/modification engine 158 of the skill based operation selection/modification engine 150, to select and/or modify operations for consideration for returning to the user as recommended operations for the use. As noted above, in some example embodiments, these operations are recipes that the user may prepare to provide food/drink items for consumption.

As a domain specific example, within the cooking domain, a user may send a request, such as via client computing device 110 and network 102, to the cognitive system 100 requesting that a recipe be provided with certain criteria, e.g., including particular ingredients and/or particular categories of dishes or food items, such as a dinner dish having chicken and potatoes, for example. For example, the cognitive system 100 may be the IBM Chef Watson™ cognitive system which is augmented by the mechanisms of the illustrative embodiments as described herein. As such, for example, a user may log onto the server 104A to gain access to the cognitive system 100 which provides one or more graphical user interfaces through which the user, via their client machine 110, enters criteria for requesting the recipe, e.g., particular ingredients to include/exclude, a meal type (e.g., breakfast, lunch, dinner, appetizer, dessert, etc.), possibly an ethnicity for the recipe, and/or other criteria. An identifier of the user, or the client machine 110, from which the request is received may be sent to the skill based operation selection/modification engine 150 for use in assisting with the selection of candidate responses to the user's request.

Based on the user identifier, or client machine 110 identifier, a corresponding user profile may be retrieved from the user profiles knowledge base 162 or a default profile may be utilized if the user does not have their own associated user profile in the user profiles knowledge base 162. The user profile identifies a set of skills and/or skill limitations associated with the user. These skills and/or skill limitations may be associated with domain specific actions via the associations identified by the skill-domain action correlation engine 152 as discussed above. The result is a set of domain specific actions that the user is able to perform, e.g., cooking actions and/or ingredient preparation actions, such as may be identified in domain actions/entities knowledge base 160. This set of domain specific actions may then be used as filter criteria for selecting operations, e.g., recipes, from the operations knowledge base 166 which the user is able to achieve or perform successfully, based on the series of actions that need to be performed. This filter criteria may be used along with other criteria specified in the request to select one or more operations, e.g., recipes, to return as recommended operations for the user, or otherwise weight operation recommendations along with other weights as generated by the cognitive system 100 to identify a ranked listing of candidate operation recommendations.

For example, a subset of operations from the operations knowledge base 166, e.g., recipes from the recipe knowledge base, may be selected that have actions where all of the actions of the operation (recipe) are able to be performed by the user as determined from the user profile and the association of skills/skill limitations of the user with domain specific actions. These recipes may have their weights increased, while recipes having actions that the user is not able to perform or which match, e.g., violate, skill limitations of the user may have their weights decreased, or may serve as the set of potential candidate responses that are further evaluated by the request processing pipeline 108 of the cognitive system 100 so as to generate a ranked listing of candidate responses and/or a final response, e.g., a final recipe recommendation. For example, if the user is determined to have a skill limitation of weak hand strength, then recipes that do not require actions which would call for strong hand strength will have their weights increased while recipes that have actions that require strong hand strength, e.g., kneading bread or the like, may have their weights decreased.

In some cases, where recipes are generated dynamically by the cognitive system 100, the skills and/or skill limitations of the user may be used to filter out or modify domain specific actions that may be added to the dynamically generated recipe. For example, the cognitive system 100 may determine, based on the ontology 164, that an action is to be added to the dynamically generated recipe and may check that action against the skills and/or skill limitations of the user. If the check indicates that the user has the requisite skills to perform the action, based on the skill-domain action associations generated by the engine 152, then the action may be added to the dynamically generated recipe. If the user does not have the requisite skill or the action violates a skill limitation of the user, then an alternative action may be selected. The actions and alternative actions may be selected based on the domain specific ontology knowledge base 164 which may associate domain specific actions and entities of similar type with each other. For example, if a domain specific action is to “chop” the ingredient, and the user has a weak hand strength skill limitation, then an alternative action may be selected from the ontology 164 of the type, add pre-cut vegetables from grocery.

For example, assume that a user submits a request to the cognitive system 100 requesting a recipe that has both chicken and rosemary as ingredients. The user's user profile is retrieved by the operation selection/modification engine 158 from the user profiles knowledge base 162 and it is determined that the user has a skill limitation that they have weak hand strength due to a medical condition of rheumatoid arthritis as identified from the user's patient EMRs. Thus, the user is not able to cut, chop, or slice the chicken. Hence, the skill based operation selection/modification engine 150 may select recipes from the knowledge base 166 and/or generate a recipe with actions that do not require strong hand strength, such as may be selected from the ontology 164. For example, instead of a recipe that includes the action of “cut the chicken breast”, an alternative recipe may be selected/generated that includes the action of “bake the chicken breast” and does not include an action requiring the cutting, chopping, or slicing of the chicken.

As another example, consider a request for a recipe to make a soup in which case, rather than preparing the chicken to make broth, the user may be able to use chicken bouillon to flavor the soup. As yet another example, rather than the user making croissant dough which requires kneading, the system may recommend that the user use a pre-made store bought dough. In another example, rather than making the recipe Chicken Milanese, which requires pounding the chicken, baked chicken can be substituted. In still a further example, in a recipe requiring finely chopped nuts for a dessert, the use of a food processor may be used rather than requiring the user to chop the nuts themselves. Thus, in general, in the recipe domain in accordance with some illustrative embodiments, three different elements of a recipe may be changed or evaluated for determining an appropriateness for a user based on their skills/skill limitations, i.e. the ingredient, an action to be performed, or the entire recipe.

In some illustrative embodiments, as mentioned above, rather than selecting/generating recipes in which all of the cooking actions or ingredient preparation actions are able to be performed by the user, weightings may be applied to the recipes based on the degree of correlation between the actions in the recipes and the skills/skill limitations of the user. Those recipes for which the user has skills to perform the actions may be weighted more heavily than recipes for which the user has skill limitations. The selected/generated set of recipes and/or the weightings may be provided to the cognitive system 100 for further evaluation by the request processing pipeline 108, e.g., the selected/generated set of recipes and their weightings may be supplied to the request processing pipeline 108 as candidate responses to the user for further evidential evaluation, merging, ranking, and final response selection.

The weights associated with these recipes may be considered user skill weighting values that weight the correctness of the recipe as a correct recommendation for the particular user based on how well the actions of the recipe match the skills of the user for which the recipe is considered as a potential recommendation. The user skill weighting values may be combined with other weighting values utilized by the request processing pipeline 108 of the cognitive system 100 when evaluating candidate recommendations or response to user requests. Such additional weighting values may include evidential weighting values which, along with the user skill weighting values, are combined in an implementation specific manner to generate a confidence score for each of the candidate responses or recommendations. The confidence scores generated may then be used to rank the candidate responses or recommendations relative to one another and one or more final recommendations/responses may be returned to the user as a response to their original request.

In some illustrative embodiments, in addition to, or in replacement of, the filtering out of complete operations based on the skills and/or skill limitations of the user in the user profile, or applying/modifying weights associated with operations requiring skills that violate skill limitations of a user, the illustrative embodiments may also determine modifications to one or more operations, e.g., recipes, that would accommodate the skills and/or skill limitations of the user. These modifications may replace or otherwise modify individual actions in a series of actions required to achieve the operation successfully, e.g., preparation of food/drink item according to the recipe, so that the replacement or modified action is one that can be performed by the user taking into account the user's skills and/or skill limitations. For example, if a recipe calls for chopped vegetables, but the user has difficulty chopping vegetables, the recipe may be modified to replace this action with an action to add pre-cut vegetables. As another example, the recipe may call for the user to knead bread, however if the user has a sprained wrist this may be painful, and thus, this action may be replaced with an action to use a bread machine to knead the bread.

The ontology 164 may be searched for corresponding actions/entities that may be used for replacement of actions in an operation, e.g., recipe. That is, the ontology 164 may comprise nodes representing actions/entities and links that connect these actions/entities which may be organized in accordance with actions/entities that are similar. In some cases, the ontology 164 may have clusters of similar actions/entities that can be used as replacements of each other. These actions/entities may have corresponding attributes that may be correlated with skills and/or skill limitations such that appropriate actions/entities may be selected in accordance with the user's skills and/or skill limitations as determined from the user profile.

Based on the selection of one or more operations, e.g., recipes, from the operation knowledge base 166, weighting of the one or more operations based on the degree of matching of skills and/or skill limitations, possible modification of actions of the one or more operations based on the user's skills and/or skill limitations, and the like, as noted above with regard to one or more of the described illustrative embodiments, the set of one or more operations may be provided to the cognitive system 100 for further evaluation by the request processing pipeline 108. The request processing pipeline 108 may perform evidential evaluation, ranking, merging, and selection of one or more final recommendations of operations to be returned to the user in response to their request, e.g., a response is transmitted back to the originating client device 110 by the server computing device 104A via the network 102. The response may be presented as one or more graphical user interfaces (GUIs) through which the details of the operation may be presented to the user, e.g., the actions of the recipe may be listed along with a listing of ingredients, pictures of the food/drink item, links to resources where more information about ingredients, utensils, appliances, and the like may be provided, and the like.

In addition, the GUIs may include GUI elements through which the user may provide feedback information to the cognitive system 100 about the recipe as a whole and/or individual actions present in the recipe. For example, the user may specify a qualitative evaluation of the recipe as a whole, a qualitative evaluation of individual actions in the recipe, and/or the like. In particular, the user may specify that the recipe as a whole was or was not a good recommendation for this particular user. In addition, the user may specify that individual actions were or were not able to be performed or otherwise provide an indicator of an amount of difficulty the user had in performing the action. For example, a user may indicate that the action of kneading bread was particularly difficult for them or that the recipe as a whole was a good recommendation.

This feedback information may be provided back to the cognitive system 100 which may then provide the feedback to the skill based operation selection/modification engine 150. The skill based operation selection/modification engine 150 may then modify the operational parameters of the operation selection/modification engine 158 based on the feedback and the association of the feedback with the user profile. For example, the operation selection/modification engine 158 may be adjusted based on the feedback that the user had difficulty kneading bread, and the user profile indicating that the user has weak hand strength, to learn the association of kneading bread as an action that should not be recommended to users that have weak hand strength. These associations may be stored in the skill-domain action correlations generated by the skill-domain action correlation engine 152. In this way, a machine learning approach is applied to the learning of the correlation of skills and/or skill limitations with domain specific actions.

Thus, the illustrative embodiments provide mechanisms for assisting with the recommendation of operations, such as recipes, that a user can successfully achieve by taking into consideration the user's skills and/or skill limitations with regard to the actions that need to be performed to achieve successful completion of the operation. In the context of a cooking domain, a cognitive system based methodology, computer program product, and apparatus are provided which generates recommendations for recipes and/or modifications to recipes that the user's available skills will allow them to complete. In so doing, recipes that require skills that the user does not have or that match skill limitations of the user may be automatically removed from consideration or modified. Thus, recommendations generated by a cognitive system, such as IBM Chef Watson™, may be made more accurate and personalized to the particular user and their current skills and skill limitations.

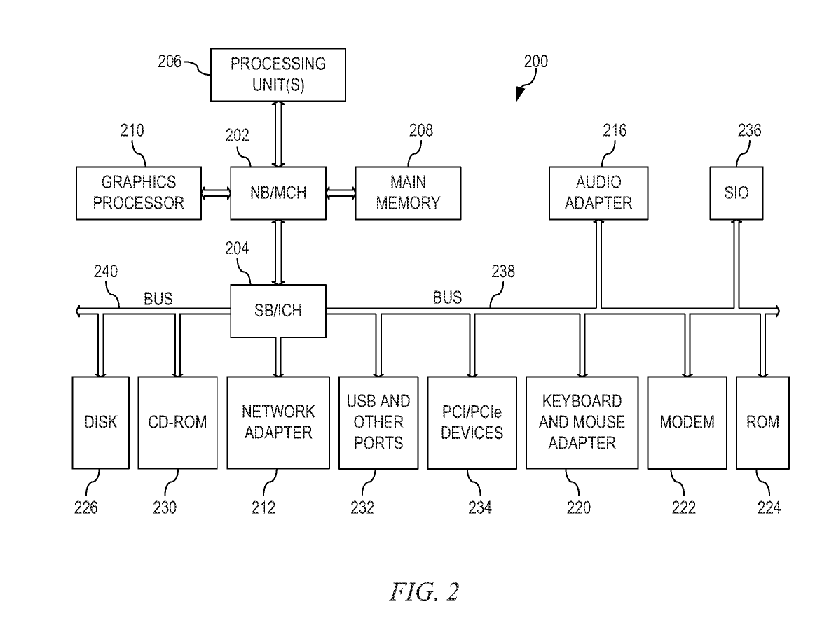

As noted above, the mechanisms of the illustrative embodiments are rooted in the computer technology arts and are implemented using logic present in such computing or data processing systems. These computing or data processing systems are specifically configured, either through hardware, software, or a combination of hardware and software, to implement the various operations described above. As such, FIG. 2 is provided as an example of one type of data processing system in which aspects of the present invention may be implemented. Many other types of data processing systems may be likewise configured to specifically implement the mechanisms of the illustrative embodiments.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and request processing pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 10®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System P® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates an example of a cognitive system processing pipeline which, in the depicted example, is a question and answer (QA) system pipeline used to process an input question in accordance with one illustrative embodiment. As noted above, the cognitive systems with which the illustrative embodiments may be utilized are not limited to QA systems and thus, not limited to the use of a QA system pipeline. FIG. 3 is provided only as one example of the processing structure that may be implemented to process a natural language input requesting the operation of a cognitive system to present a response or result to the natural language input.

The QA system pipeline of FIG. 3 may be implemented, for example, as QA pipeline 108 of cognitive system 100 in FIG. 1. It should be appreciated that the stages of the QA pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA pipeline 300 comprises a plurality of stages 310-380 through which the cognitive system operates to analyze an input question and generate a final response. In an initial question input stage 310, the QA pipeline 300 receives an input question that is presented in a natural language format. That is, a user inputs, via a user interface, an input question for which the user wishes to obtain an answer, e.g., “Who are Washington's closest advisors?” In response to receiving the input question, the next stage of the QA pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA pipeline 300 and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 300 that identifies a manner by which these scores may be combined to generate a confidence score or measure for the individual hypotheses or candidate answers. This confidence score or measure summarizes the level of confidence that the QA pipeline 300 has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

As shown in FIG. 3, in accordance with one illustrative embodiment, the pipeline 300 operates in conjunction with a skill based operation selection/modification engine 150, which operates based on knowledge base resources 160-166, as previously described above with regard to FIG. 1, to identify operations (e.g., recipes) that are able to be successfully completed by the user submitting the input question or request 310 based on a corresponding user profile and the skills/skill limitations of the user specified in the user profile. As discussed above, the skill-domain action correlation engine 152 performs operations based on the knowledge bases 160-166 to learn associations of skills and/or skill limitations with domain specific actions such that a skill mapping data structure 390 is generated that maps skills and/or skill limitations to associated domain specific actions, where information about domain specific actions and entities upon which these actions are performed may be obtained from the knowledge base 160 and ontology 164, for example.

The user skill/skill limitation analysis engine 154 may operate on information in the corpus or corpora 345, 347 to obtain knowledge of user characteristics and the corresponding skills/skill limitations associated with these user characteristics, e.g., correlation of medical maladies with particular pre-defined skills and/or skill limitations. This correlation may further be added to the skill mapping data structures 390 such that skills/skill limitations are correlated with domain specific actions and with user characteristics.

The user profile engine 156 performs operations as discussed above to generate a user profile for a user and store that user profile in knowledge base 162 for later retrieval and use. The user profile engine 156 may obtain information about the user's skills and/or skill limitations in various ways as discussed above including using ADL sensors and ADL analysis mechanisms, such as ADL analysis engine 140, obtaining user input specifying skills and/or skill limitations, machine learning from previous actions performed by the user, analysis of the user's patient EMRs or other information indicating the users medical condition based skill limitations, and the like. For example, the user profile engine 156 may analyze patient EMRs for indicators of various medical conditions that represent disabilities or limitations with regard to the user's physical abilities, such as cerebral palsy, muscular dystrophy, multiple sclerosis, spina bifida, ALS (Lou Gehrig's Disease), Arthritis, Parkinson's disease, broken bones, sprains and strains, etc.

The operation selection/modification engine 158 operates, in response to the cognitive system 100 receiving a request from a particular user, to retrieve a user profile for the user from the user profiles knowledge base 162 and apply the skills and/or skill limitations specified in the user profile to operations (e.g., recipes) specified in the operations knowledge base 166, to select/generate and/or modify one or more operations (e.g., recipes) for which the user has the skills to successfully complete the operation by performing all of the actions in the operation. In some embodiments, the user's skills and/or skill limitations in the user profile are correlated with domain specific actions based on the mapping in the skill mapping database 390 which provides a listing of actions that the user is able to perform and these actions may be matched to actions in the operations of the knowledge base 166. Based on a degree of matching, operations may be selected from the operation knowledge base 166 for candidates recommendations for the user. For example, a threshold value may be set indicating a degree of matching required for the selection of an operation as a candidate recommendation for further evaluation. If this threshold value is met or exceeded by the degree of matching of actions, then the operation may be selected as a candidate recommendation.

As noted above, part of this process may be to weight operations (e.g., recipes) based on the degree by which the actions of the operations match the skills of the user (or not). Thus, in some cases, all of the operations in the knowledge base 166 are made available to the cognitive system 100 for evaluation, but with user skill weight values being applied based on the correlation of the actions with the skills and/or skill limitations of the user specified in the user profile such that operations will have different user skill weight values when further evaluated by the pipeline 300. In some embodiments, the user skill weights may be used to generate a numerical representation of the degree of matching of the actions that the user is capable of performing with the actions required by the operation, which can then be compared to the threshold value as discussed above to select a subset of the operations from the operations knowledge base 166 as candidate recommendations for further evaluation by the pipeline 300.

Moreover, in some illustrative embodiments, the operation selection/modification engine 158 may, for operations that score poorly based on the degree of matching of actions the user can perform with those required by the operation, determine modifications to the operation that can increase the degree of matching. These modifications may be identified based on the ontology knowledge base 164 which may cluster similar actions/entities with each other such that alternatives are identified. In particular, the ontology knowledge base 164 may be searched based on the action to be replaced and the actions that the user is able to perform to identify an alternative that satisfies providing a similar result as the action to be replaced but which can be performed by the user based on the actions the user is able to perform as identified by the user profile.

Either all of the operations in the operations knowledge base 166 with their associated user skill weight values, or a subset of the operations as selected based on the degree of matching, may be provided to the pipeline 300 for further evaluation. For example, these operations may be provided to the hypothesis generation stage logic 340 or hypothesis and evidence scoring stage logic 350, for use as the hypotheses for further evaluation. The further evaluation may take the form previously discussed in which evidential passages from the corpus or corpora 345, 347 may be evaluated to generate a confidence score for each of the candidate recommendations, which may then by synthesized, merged, and ranked. Then a final “answer” or recommendation may be selected for output back to the user as a response to their original request. Thus, by providing the skill based operation selection/modification engine 150, the hypotheses that are evaluated are selected or ranked based on the user's skills and/or skill limitations in addition to the other evaluation criteria performed by the pipeline 300.

As mentioned previously, in some illustrative embodiments, the skill based operation selection/modification engine 150 performs machine learning of the associations of skills and/or skill limitations with domain specific actions based on feedback received from users with regard to recommendations provided to them and their subjective evaluation of the appropriateness of the recommended operation and/or actions within the recommended operation. In particular, within a cooking domain, a user may provide feedback as to the qualitative evaluation of the recipe that was recommended as well as the individual cooking or ingredient preparation actions that are part of the recipe relative to the user's skills and/or skill limitations.

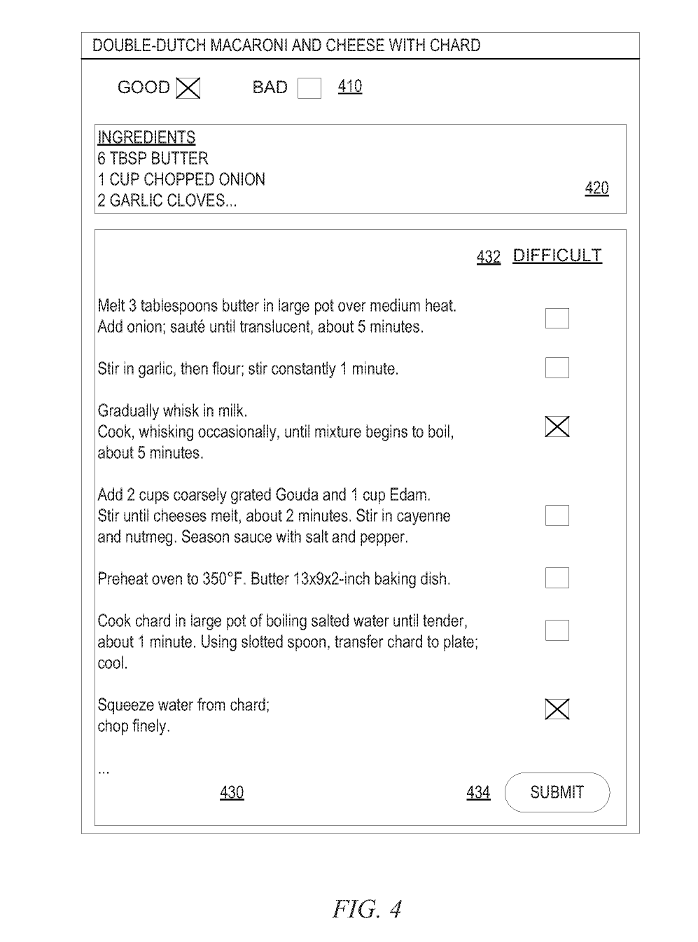

FIG. 4 is an example diagram of a recipe GUI output with user feedback elements in accordance with one illustrative embodiment. As shown in FIG. 4, the GUI includes user feedback GUI elements 410 that indicate the qualitative evaluation of the recipe as a whole, an ingredients listing 420, and a recipe actions listing 430. The recipe actions listing further includes, for each action, or group of related actions, a user feedback GUI element 432 for indicating whether the particular action or group of related actions were considered to be difficult to perform by the user. A user may select those actions that user had difficulty completing 432 as well as indicate whether the recipe as a whole was a good recommendation or not 410 and may submit the feedback via the submit GUI element 434.

For example, in the depicted example, a user may have rheumatoid arthritis and thus, may have found the actions of whisking, squeezing, and chopping to be difficult and may select the GUI elements 432 corresponding to those actions, or groups of related actions, to indicate that those actions/groups of actions were difficult to achieve. However, the user may have found the action of stirring to not be difficult and thus, may not mark those actions as difficult. The user may then submit this feedback to the cognitive system by pressing the submit GUI element 432. The cognitive system may provide this feedback to the skill based operation selection/modification engine 150 to machine learn the association of skills and/or skill limitations of the user, in the user profile, with the actions for which feedback is provided. For example, for those actions that indicate difficulty in the feedback, the association of skill limitations with these actions may be increased in the skill mapping database 390 indicating that these skill limitations prevent these actions from being performed successfully. For those actions in the recipe that were not indicated to be difficult, the skill mapping database 390 associations may be increased in value indicating a stronger association that these actions are achievable by users with the skills and/or skill limitations of this particular user. The strengths of such associations may be weighting values that may be applied, as with the other weighting values mentioned previously, when evaluating operations in the operations knowledge base 166 and modifications in the ontology 164.

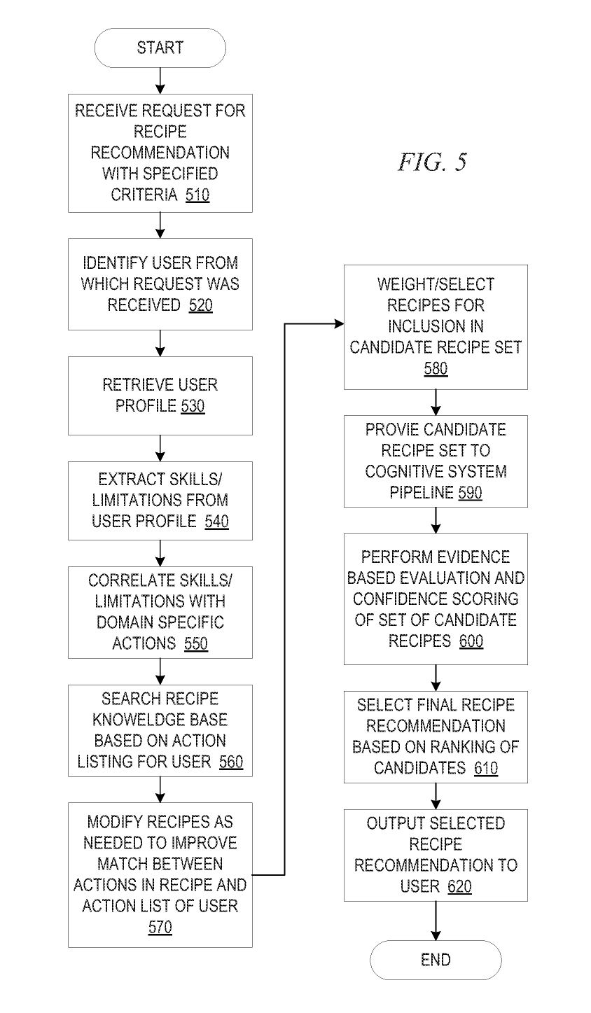

FIG. 5 is a flowchart outlining an example operation for providing a recommended recipe in accordance with one illustrative embodiment. The operation outlined in FIG. 5 may be performed by a skill based operation selection/modification engine, such as engine 150 in FIGS. 1 and 3, for example. The operation outlined in FIG. 5 assumes that a skill mapping data structure has already been generated, such as in the manner previously described above with regard to one or more of the illustrative embodiments, so that skills and/or skill limitations are mapped to domain specific actions and to user characteristics.

As shown in FIG. 5, the operation starts by receiving a request from a user for a recipe recommendation (step 510). The request may specify criteria for the recommended recipe including, for example, one or more ingredients to include/exclude, an ethnicity of the recipe, a meal type with which the recipe is associated (e.g., appetizer, breakfast, lunch, dinner, snack, dessert), and the like. An identifier of the user is extracted from the request or connection information associated with the connection via which the request is received (step 520). The user identifier is used to retrieve a user profile associated with the user from a user profile knowledge base (step 530). In the case that a specific user profile for this user is not present, a default user profile may be utilized, such as one in which there are no skill limitations indicated and all skills are assumed to be present.

The skills and/or skill limitations for the user are extracted from the user profile (step 540) and correlated with domain specific actions based on a skill mapping data structure (step 550). A recipe knowledge base is then searched to identify recipes for which the user's associated action list matches the actions of the recipe (step 560). Moreover, as part of this process, the recipes in the recipe knowledge base may be analyzed to determine if there are alternative actions that may be used to replace actions in the recipes so as to make them match to a greater extent the actions that the user is capable of performing as indicated by their user profile and the skills/skill limitations specified therein (step 570). Those recipes identified and/or modified may be weighted and/or selected for inclusion in a candidate recipe set (step 580). For example, user skill weighting values may be applied to the recipes based on a degree of matching of the actions that the user can perform and the actions required by the recipe to thereby score the recipes with regard to user skills and/or skill limitations. The scoring of the recipes based on the user skill weighting values may be compared to a threshold value to determine if requirements of the threshold value are satisfied or not and if so, those recipes are selected as candidate recommendations. Alternatively, all of the recipes may be provided as candidate recommendations, but with different scores based on user skill weighting values such that some recipes are more heavily weighted (or scored) than others.

The selected recipes and/or weighted recipes may be provided to a cognitive system pipeline for further evaluation (step 590). The cognitive system pipeline performs evidence based evaluation and confidence scoring, which may take into account the user skill based scores generated for the various recipes, to generate a ranked candidate set of recipe recommendations (step 600). For example, the set of candidate recipes may be further evaluated with regard to the other criteria specified in the user's request, e.g., ingredients to include/exclude, ethnicity, meal type, etc., and further based on evidence passages found in a corpus or corpora that may be indicative of the appropriateness of the particular recipe for the user's criteria specified in the request. A final recipe recommendation is then selected from the ranked candidate set, e.g., a highest ranked candidate recipe recommendation (step 610). The selected final recipe is output to the user as a recipe recommendation in response to the user's original request (step 620) and the operation terminates.

Thus, the illustrative embodiments provide mechanisms for selecting and/or modifying operations, such as recipes, based on the skills and/or skill limitations associated with a user. In some cases, these skills and/or skill limitations are due to medical conditions of the user and thus, the illustrative embodiments may be used to identify those operations that the user can perform successfully given their particular medical condition, whether it be temporary or more permanent. As a result, operation recommendations are made more applicable to the particular user requesting them. In the context of an intelligent chef based cognitive system and the cooking domain, the illustrative embodiments provide mechanisms for providing recipe recommendations that take into consideration the cooking/ingredient preparation actions required to prepare the recipe and the user's skills and/or skill limitations with regard to performing such cooking/ingredient preparation actions.

It should be appreciated that while the above illustrative embodiments are described in the context of an edible recipe for making an edible dish or meal for human consumption, the illustrative embodiments are not limited to such. To the contrary, the mechanisms of the illustrative embodiments may be applied to “recipes” and “ingredients” in other domains where work products are created by assembling various constituents according to specified instructions. That is, the recipes of the illustrative embodiments are a listing of constituent elements with instructions for preparing and/or combining these constituent elements. Examples include material objects and manufactured goods, such as electronic circuits, furniture, pharmaceuticals, toys, sporting equipment, or any other physical work product created by combining other physical components together in accordance with assembly instructions to generate the physical or material work product. Moreover, the illustrative embodiments may be applied to abstract objects, such as complex travel itineraries, financial portfolios, computer programs, or any other abstract work product. Thus, the mechanisms of the illustrative embodiments may be utilized with any domain where a work product is generated using such constituent elements in accordance with such specified instructions.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, the memory comprising instructions which are executed by the processor to perform the method, wherein the method comprises:
obtaining, by the data processing system, user data associated with a user;
determining, by the data processing system, one or more user skills of the user based on analysis of the user data;
analyzing, by the data processing system, characteristics of tasks of a plurality of user operations stored in user operation data structures in a user operations knowledge database;
identifying, by the data processing system, a subset of user operations for which, for each task of each operation in the subset of operations, there is a match of the one of more user skills of the user with one or more required skills for performing the task;
selecting, by the data processing system, a recommended user operation from the subset of operations; and
outputting, by the data processing system, the recommended user operation to a computing device associated with the user.

2. The method of claim 1, further comprising correlating the one or more user skills of the user with one or more domain specific actions that the user is able or unable to perform based on a domain of the plurality of user operations.

3. The method of claim 2, wherein the one or more user skills comprise information defining one or more user skill limitations that restrict the user's ability to perform particular domain specific actions.

4. The method of claim 1, further comprising:
receiving, by the data processing system, a request from the user for a selection of a user operation from the plurality of user operations, or dynamic generation of a user operation, to be performed by the user, wherein the request specifies one or more criteria for the user operation; and
determining, by the data processing system, based on the request, an identifier of the user, wherein obtaining the data about the user comprises retrieving a user profile corresponding to the user based on the determined identifier of the user, and wherein determining the one or more user skills of the user comprises retrieving the one or more user skills of the user from the retrieved user profile.

5. The method of claim 1, wherein obtaining user data comprises receiving, by the data processing system, sensor data from one or more sensors, the one or more sensors selected from a group including a wearable sensor worn by the user, an image sensor capturing images of an environment in which the user is present, and an audio sensor capturing audio in the environment in which the user is present.

6. The method of claim 1, wherein the one or more user skills of the user comprise at least one of physical skills for physically manipulating elements of an environment or mental skills for handling a task.

7. The method of claim 1, wherein the one or more user operations are food or drink item preparation operations specified in one or more food or drink preparation recipes, the one or more user skills are one or more food or drink preparation skills, and selecting a recommended user operation from the subset of operations comprises generating a recommendation with respect to the one or more food or drink preparation recipes.

8. The method of claim 1, wherein the selecting a recommended user operation comprises modifying at least one task of a user operation in the plurality of user operations based on the one or more user skills, wherein the modification of at least one task of the user operation includes at least one of a modification of an action to be performed by the user on an element of the task or modification of an element upon which the action is to be performed by the user.

9. The method of claim 1, wherein obtaining, by the data processing system, user data associated with a user comprises obtaining medical information about the user specifying a medical condition of the user, and wherein determining, by the data processing system, one or more user skills of the user based on analysis of the user data further comprises determining that the medical condition is associated with skill limitation defining an inability to perform a particular type of domain specific action.

10. The method of claim 1, further comprising:
receiving, by the data processing system, user feedback data from the computing device associated with the user in response to the outputting of the recommended user operation, wherein the user feedback data indicates a difficulty to perform at least one task of the recommended user operation; and
modifying, by the data processing system, at least one attribute of a computing model used to identify the subset of user operations based on the user feedback data.

11. A computer program product comprising a computer readable storage medium having a computer readable program stored therein, wherein the computer readable program, when executed on a data processing system, causes the data processing system to:
obtain user data associated with a user;
determine one or more user skills of the user based on analysis of the user data;
analyze characteristics of tasks of a plurality of user operations stored in user operation data structures in a user operations knowledge database;
identify a subset of user operations for which, for each task of each operation in the subset of operations, there is a match of the one of more user skills of the user with one or more required skills for performing the task;
select a recommended user operation from the subset of operations; and
output the recommended user operation to a computing device associated with the user.

12. The computer program product of claim 11, wherein the computer readable program further causes the data processing system to correlate the one or more user skills of the user with one or more domain specific actions that the user is able or unable to perform based on a domain of the plurality of user operations.

13. The computer program product of claim 12, wherein the one or more user skills comprise information defining one or more user skill limitations that restrict the user's ability to perform particular domain specific actions.

14. The computer program product of claim 11, wherein the computer readable program further causes the data processing system to:
receive a request from the user for a selection of a user operation from the plurality of user operations, or dynamic generation of a user operation, to be performed by the user, wherein the request specifies one or more criteria for the user operation; and
determine, based on the request, an identifier of the user, wherein the computer readable program further causes the data processing system to obtain the data about the user at least by retrieving a user profile corresponding to the user based on the determined identifier of the user, and wherein the computer readable program further causes the data processing system to determine the one or more user skills of the user at least by retrieving the one or more user skills of the user from the retrieved user profile.

15. The computer program product of claim 11, wherein the computer readable program further causes the data processing system to obtain user data at least by receiving, by the data processing system, sensor data from one or more sensors, the one or more sensors selected from a group including a wearable sensor worn by the user, an image sensor capturing images of an environment in which the user is present, and an audio sensor capturing audio in the environment in which the user is present.

16. The computer program product of claim 11, wherein the one or more user skills of the user comprise at least one of physical skills for physically manipulating elements of an environment or mental skills for handling a task.

17. The computer program product of claim 11, wherein the one or more user operations are food or drink item preparation operations specified in one or more food or drink preparation recipes, the one or more user skills are one or more food or drink preparation skills, and wherein the computer readable program further causes the data processing system to select a recommended user operation from the subset of operations at least by generating a recommendation with respect to the one or more food or drink preparation recipes.

18. The computer program product of claim 11, wherein the computer readable program further causes the data processing system to select a recommended user operation at least by modifying at least one task of a user operation in the plurality of user operations based on the one or more user skills, wherein the modification of at least one task of the user operation includes at least one of a modification of an action to be performed by the user on an element of the task or modification of an element upon which the action is to be performed by the user.

19. The computer program product of claim 11, wherein the computer readable program further causes the data processing system to obtain user data associated with a user at least by obtaining medical information about the user specifying a medical condition of the user, and wherein the computer readable program further causes the data processing system to determine one or more user skills of the user based on analysis of the user data at least by determining that the medical condition is associated with skill limitation defining an inability to perform a particular type of domain specific action.

20. An apparatus comprising:
a processor; and
a memory coupled to the processor, wherein the memory comprises instructions which, when executed by the processor, cause the processor to:
obtain user data associated with a user;
determine one or more user skills of the user based on analysis of the user data;
analyze characteristics of tasks of a plurality of user operations stored in user operation data structures in a user operations knowledge database;
identify a subset of user operations for which, for each task of each operation in the subset of operations, there is a match of the one of more user skills of the user with one or more required skills for performing the task;
select a recommended user operation from the subset of operations; and
output the recommended user operation to a computing device associated with the user.
